(19) United States
(12) Patent Application Publication
(10) Pub. No.: US 2018/0060994 A1
(43) Pub. Date: Mar. 1, 2018

(54) System and Methods for Designing Unobtrusive Video Response Codes

(71) Applicant: Grace Rusi Woo, San Francisco, CA (US)

(72) Inventor: Grace Rusi Woo, San Francisco, CA (US)

(21) Appl. No.: 15/249,411

(22) Filed: Aug. 27, 2016

(51) Int. Cl. G06T 1/00

(52) U.S. Cl. CPC G06T 1/0028; G06T 1/0085; H04N 5/2353; G06T 2201/0065; G06T 2201/0052

(57) ABSTRACT

System for conveying a stream of information visually and obtrusively. The system includes an encoding device employing a spatio-temporal coding scheme that omits light, including codes embedded therein that are invisible to a user. A receiver that might be a cell phone camera receives light from the encoding device and computer apparatus is programmed with software to decode the received light to generate the stream of information. The encoding device is preferably a video display.

### CROSS REFERENCE TO RELATED APPLICATION

This application claims priority to provisional application Ser. No. 62/210,539, filed on Aug. 27, 2015, the contents of which are incorporated herein by reference; in their entirety,

### FIELD OF THE INVENTION

Time domain based watermarking, e.g. watermarks spread over several images (G06T2201/0085); Embedding of the watermark in the frequency domain (G06T2201/0052); adaptive watermarking, e.g. Human Visual System (HVS)-based watermarking (G06TT,0028)

The present invention relates to the design and methods surrounding Video Response Codes and in particular to U.S. Ser. No. 13/632,422 filed Oct. 1, 2012 in its entirety.

### BACKGROUND

Video Response Codes (VR Codes) are codes that establish an unobtrusive visual light communication link from live screens (e.g., LCD monitors, televisions, projectors, etc.) to devices with digital photo-sensor arrays (cameras, mobile devices, etc.). “Unobtrusive” can mean that the communication link, despite being composed of visible light, is barely perceptible to human vision.

Consider the scenario depicted in FIG. 1, which shows two information streams including a still image or video referred to as the “primary information” or “substrate image” and a stream of binary data referred to as the “secondary information” or simply “data.” FIG. 1 also shows a screen which acts as the transmitter of information, a human observer interested in viewing the substrate image, and a device interested in receiving the data, equipped with a digital camera. FIG. 1 further shows a visual response coding system including (1) a sender which takes a sequence of primary data image frames and a sequence of secondary binary data as input and outputs a sequence of processed image frames to the live screen for display; and (2) a receiver which captures image(s) of the screen using a digital camera and processes these to estimate (decode) the sequence of secondary data bits.

In general, screens exist for the purpose of displaying image or video, and therefore the added benefit offered by VRCodes lies in simultaneously using visual light to communicate the data to the device. Though one can easily imagine methods of screen-to-device communication that the human viewer may describe as obtrusive (e.g., reserving a portion of the screen for q QR code). Hence, there is a need for VRCodes that are unobtrusive. Specifically, there is a need to (1) convey the substrate image to the human observer with bounded obtrusiveness, while (2) communicating data as reliably and at as high of a rate as possible to the device, or explicitly:

maximize COMMUNICATION EFFICIENCY, (1)

subject to OBTRUSIVENESS≦MAX. (2)

### SUMMARY

The present technology is focused on designing VR codes that are unobtrusive. That is, the VR coding schemes of the present technology can use visual light communications (VLC) systems that “embed” data within the “substrate” of the primary image in a way that the data is hidden from the human observer.

The human eye and brain do not see in the same way that the cameras on mobile devices do. The present technology identifies and quantifies the ways humans see as relevant to the development of unobtrusive, machine-decodeable digital overlays for ordinary display screens and cameras. The understanding and methods developed in this technology can be used in a wide range of off-the-shelf displays and cameras.

In one aspect, a mathematical model and engineering approximation of the Human Visual System (HVS) is created for unobtrusive visual communication. This includes identifying a single dimension for approximating the effect that VRCodes have toward triggering rods in the human eye and approximating the way cones work within the HVS using a moving-average time-based filter.

In another aspect, VRCodes are made to be unobtrusive on 60 Hz displays. Previously, unobtrusive VRCodes were only achieved on 120 Hz displays. The present technology enables VRCodes for 60 Hz by customizing the CIELUV colorspace in a manner which can minimize changes in luminance from frame-to-frame. The method also involves defining a rule for capturing a temporal-based metamerism effect in the HVS that incorporates the existing understanding of flicker-fusion-frequency threshold. This can address the way cones react to color mixing temporally. In some embodiments, VRCodes for 60 Hz can be realized using a general approach to the communications encoder system that can carry data while meeting the self-defined unobtrusive criteria. This general approach can be developed by modifying classic capacity-approaching communication techniques.

In another aspect, dedicated display real estate is replaced with encoded overlays on a substrate not just limited to plain solid colors. Traditionally, VRCodes required dedicated visual real estate such as a pure-gray background to embed digital data. The ability to embed a digital code in any substrate is accomplished by: (1) developing a classic communications model that separates existing capacity-approaching communication techniques from the newly developed digital embedding techniques and (2) leveraging the defined custom colorspace to create a modulation framework that satisfies the constraints for unobtrusiveness approximated by the engineering model.

In another aspect, the present technology addresses proposed overlays using new decoding techniques. This involves using results for the concurrent unobtrusive embedding of digital data in grayscale substrates and decoding capacity. This set of techniques leverages the limited colorspace of the substrate. Another approach involves the concept of long exposure time decoding versus short exposure time decoding using existing rolling-shutter cameras to process the unobtrusive embedding techniques in the general case beyond just grayscale images.

In another aspect, software-only implementation is developed to target off-the-shelf iOS and android hardware platforms. This can involve optimizing for at least one dimension of encoding and decoding in camera sensors on mobile phones. This approach presents an alternative analysis for the trade-offs of using 1D spatial codes versus 2D spatial codes beyond the traditional capacity argument. The approach can also involve using VSync, Frame Rate Control properties in off-the-shelf hardware and software design environments.

In general, the approach of introspecting and analyzing the HVS results and comprises an engineering approximation for making a system compatible for both humans and cameras. The model for the HVS can also result in quantifiable metrics for improving the unobtrusiveness of the embedded data. The development of a colorspace and simple operations analogous to Grassmann's law can result in a mathematical method for generating lookup tables. This approach can enable the development of a real-time video encoding system.

In the present technology, the understanding of the HVS colorspace models used to develop VRCodes also relaxes the constraints on the types of devices that can support a fully working display-to-camera pipeline. For example, it relaxes the prior requirement for high refresh displays above 60 Hz.

### DETAILED DESCRIPTION

### Modeling the Human Visual System

This section includes a description of a mathematical model for the human visual system (HVS) which is used to quantify the unobtrusiveness of a VRCode. The bulk of the section presents the technical basis for the model, justified through a combination of existing HVS research and a campaign of experiments targeting specific features of VRCode designs. In particular, two key characteristics of HVS are exploited in implementations of VRCodes: Flicker Fusion and Stimulus Chromatic Vision.

Flicker fusion (FF) refers to the HVS phenomenon where, when two different sources of light are alternated (i.e., flickered) at a sufficiently high frequency, a human observer perceives the two light sources as a uniform, fused light source. As with many psycho-physical thresholds, the “sufficiently high” frequency at which the two sources perceptually fuse varies from individual to individual and may depend on many factors, such as average light intensity, phase offset and duty cycle of the flicker, spectral content of and the sources, viewer fatigue, etc. For a comprehensive presentation of many of these factors, refer to references related to the topic of the human visual system.

One factor in flicker fusion is the distinction between iso-luminant flicker and general flicker. Iso-luminance describes the scenario where the two alternating light sources are perceived by humans as having the same “brightness”, despite any chromatic differences. This distinction between iso-luminant and general flicker is important because the “sufficiently high” flicker frequency (also referred to as the critical fusion frequency or CFF) of iso-luminant sources is lower than that of general sources: Generally, the CFF of iso-luminant sources is below 25 Hz, whereas the CFF of general sources may be as high as 50 Hz. When considered in context of modern displays, this implies that many screens can induce iso-luminant flicker fusion, but cannot induce general flicker fusion: a typical screen that can display 60 frames per second can flicker between two source images at a maximum of 30 Hz. Therefore, the existing literature suggests that exploiting flicker fusion in a VRCode requires a good understanding of how the HVS interprets “luminance”.

Tristimulus Color Vision refers to the biological method through which the HVS perceives broad spectrum light in well-list settings (e.g., those driven by a screen). In such settings, the HVS relies on cone cells in the retina to process incoming light into a signal sent to the brain to interpret as a color. The well-list scenario is often referred to as “photopic” vision, during which the rod cells in the retina become less sensitive to light and thus contribute less to HVS. Cone cells may be classified into three types, each of which responds differently to the same wavelengths of light. The three types are often labeled by the range of wavelengths that induces the most neural activity—“long”, “medium”, and “short” wavelengths respectively. Consequently, with respect to the HVS, any incoming uniform light source may be expressed as a triple of values, reflecting the respective response of long, medium and short cones. This forms the basis of the LMS colorspace, a method of numerically expressing the notion of color. Other color spaces have also been defined with, for example, the intent of developing systematic methods of reproducing colors (e.g., the RGB colorspace used in digital cameras and screens and the CMYK colorspace used in print) or with the intent of emphasizing aspects of HVS (e.g. luminance-chroma separation as in CIE LUV and CIE LAB). The following two intents in colorspace definition are especially useful:
Luminance-chroma separation, which may assist the search for iso-luminant flicker.
Color mixing, which implies that mixing 50% of color A and 50% of color B results in the color represented by the point halfway between A and B in the color space.

While research on the flicker fusion and tristimulus color vision is extensive, it has largely focused on perception and reproduction of static or natural images. In order to explore the full space of possibilities for VR codes, the flicker fusion and color vision responses to non-natural images also need to be considered. Therefore, before arriving at a model of HVS, the following questions are answered using experiments:
Does the CFF behave as expected for both iso-luminant and general sources, and do specific structures (.e. unnatural elements) in the flickered images affect the quality of flicker fusion?
How should the color space be represented in order to properly isolate luminance?
Are there other aspects of HVS that become relevant in the course of experiments?

A. Flicker Fusion Experiments

The flicker fusion assumptions are verified by conducting a series of experiments that tested three dimensions of variability in order to determine how each dimension affected perceptibility of flicker. First, in order to test the effect of flicker frequency, two screens were used. Both are nominally capable of displaying 60 frames per second, and thus by multiplexing between two images capable of a 30 Hz flicker. The second screen also includes a 3-D mode, which already multiplexes between two sub-frames per frame. These sub-frames are intended to be viewed by the left and right eye respectively in order to emulate stereoscopic vision. However, this function was used to induce a 60 Hz flicker.

Second, in each experiment, pairs of images with the same optical pattern were used, but varied the pattern across experiments. Specifically, either both of the images were a solid color or both of the images consisted of the same pattern (e.g., stripes or checkerboards). Only the coloring of the pattern differed between images. Finally, a wide variety of colorings for the test image pairs was used. The only restriction on coloring was that for a subset of the experiments, approximately iso-luminant images were created, by exploiting the CIELUV colorspace (where each color is specified by three parameters L*, U*, and V*) and coloring each pattern with a palette of colors with fixed L* and varying U* and V*.

The general trends of these experiments are summarized in Table 1 FIG. 2. Some aspects of flicker fusion behaved as expected: Although 60 Hz was sufficient for general flicker fusion, (approximate) iso-luminance was required in order for fusion to occur at the lower 30 Hz.

The experiments also highlight two new issues:
In 30 Hz experiments where the color palette used a constant L*, some combinations of values for U and V resulted in the same perceptual flicker as general color palette. This was particularly true for test image pairs with high chromatic contrast, and suggests that constant L* within CIELUV is an imperfect approximation of iso-luminance. Therefore to exploit ideal iso-luminant flicker, a colorspace is redefined with a new, ideal L such that all effects of luminance are completely captured in the single coordinate. The colorspace issue is explored through further experiments described in subsequent subsections.
In experiments with optical patterns (stripes, checkerboards, etc.), although flicker was largely imperceptible when eyes were fixed, eye movement (i.e., saccading) revealed the underlying pattern. Further experiments with a number of test image pairs suggest that, regardless of the pattern (stripes, checkerboards, etc.) or colors, hard edge transitions between colors were the dominant source of saccading artifacts. In comparison, when color transition edges were smoothed or blurred resulting in a gradient instead of boundary, the effect of saccading was mitigated significantly. The effect of eye-movement requires a great deal of further study, but from these preliminary experiments, it can be conjectured that an approach similar to “pre-blurring” in image processing, or “shaping” in RF communication may help to mitigate any such saccading artifacts.

Identification of the desired colorspace. In order to identify an ideal L (i.e., one that captures all of the effects of luminance), a number of flicker experiments are run, where the observer looks at a display multiplexing two solid colors at 60 frames per second and tunes the parameters of one color until they can no longer perceive flicker. Specifically, one color is held constant, while the other as well as the direction of the tunable parameter is varied. The result is a list of pairs of colors which are perceived as iso-luminant with the color held constant. These values are then plotted in various colorspaces and with a surface fitted, as shown in FIG. 3.

The following observations are made:
Iso-luminance is transitive, confirming that there exists L that predicts the perception of luminance flicker;
The photometric luminance as defined by the CIE, denoted as Y in the CIEXYZ and L* in the CIELUV and CIELAB colorspaces, is a near fit. However, due in part to imperfect calibration of display monitors, the iso-luminant surface is a plane at a slight angle from the plane of equal photometric luminance. Thus, when the two multiplexed colors are far apart within the colorspace, their flicker luminance needs to be adjusted proportionately.

To exploit flicker fusion in 60 frame-per-second screens, an iso-luminance constraint is imposed: L is held constant between flickering elements. Therefore, we have available degrees of freedom only the part of the color space C which is independent of L. After removing from the 3-dimensional space C its projection onto L, the space of interest has only two remaining degrees of freedom. We have found that for practical purposes the CIELUV colorspace approximately preserves the perceived mixing of colors when multiplexed temporally.

HVS Model: In some embodiment, a signal model to describe the interaction between what a screen displays, Θ(t), and what a human perceives, Ψ(t). The metric to measure obtrusiveness given the signal model. A depiction of the signal model is given in FIG. 4 where the initial display image, Θ(t), undergoes three subsequent signal distortions before arriving at a perceived image, Ψ(t). The representation of the display and perceived images (namely the color space) as well as the three signal distortions are all key components in the signal model, and each corresponds to a specific observed HVS characteristic.

Let the displayed image, Θ(t), for a single value oft be a 2-dimensional array whose size is given by the resolution of the screen, WIDTH×HEIGHT, measured in pixels. Each element in the 2-D array, Θ_{i,j}(t) for (1,1)≦(i, j)≦(WIDTH, HEIGHT), consists of a color triple from the embodied colorspace. The continuous time process Θ(t) for all values of t therefore represents everything that a screen displays.

Individual colorspace channels are separated as two separate 2-D array processes representing luminance and chromaticity, Θ^{L}(t) and Θ^{UV}(t).

The first HVS characteristic included in the signal model accounts for the visual acuity (VA) of the observer. To model VA, a temporally constant and linear shift-invariant point spread function (e.g., blur or spatial low pass filter) is used, H_{VA}^{L}. It is assumed that the point spread function may be split into separate channels, H_{VA}^{L} and H_{VA}^{UV}. An intermediate image process for a channel with label c, denoted as Φ(t), is given by

Φ^{c}(t)=H_{VA}^{c}*Θ^{c}(t), (3)

where * represents convolution.

The second HVS characteristic captured in the embodied model is eye movement. Eye movement is defined by a spatial random process Δ(t) which a two-dimensional random walk on a Cartesian grid.

The final characteristic of HVS considered by this embodiment is flicker fusion (FF). In order to model flicker fusion, for the time-varying process representing each pixel we apply a (low pass) causal, linear time-invariant filter h_{FF}(t). As with the point spread function used to model visual acuity, it is assumed that the particular flicker fusion filter may be separated into independent channels.

An individual channel of the perceived image, Ψ(t), with label c is consequently given by the following:

Ψ_{i,j}^{c}(t)=∫₀^{∞}h_{FF}^{c}(τ)Φ_{δ}_{ᵢ}_{(t-τ)+i,δ}_{ⱼ}_{(t-τ)+j}^{c}(t−τ)dτ, (4)

Note that the order in which distortions are applied is intended to approximately mimic the sequence of physical sources producing the corresponding HVS phenomenon. Visual acuity is dependent on the ability of the lens to focus light on the retina, eye movement is a result of physically moving the lens and retina relative to the screen, and recently it was shown that flicker fusion may be a purely cortical phenomenon.

Given the signal model, we now define the obtrusiveness of a VR code. For any fixed VR code, let Ψ_{VR}(t) be the resulting perceived image process and Ψ₀(t) be the perceived image if no VR code is used. The visual acuity and flicker fusion filters as well as the eye movement sample paths that results in Ψ_{VR}(t) and Ψ₀(t) are the same. The obtrusiveness is defined as

OBTRUSIVENESS=E[∥Ψ_{VR}(t)−Ψ₀(t)∥_{K}], (5)

where expectation is in an ergodic sense and K is a weighting matrix for the Euclidean vector norm.

### Generating VRCode Images for Temporal Multiplexing

By addressing the HVS metrics developed in the previous section, the practical design of an unobtrusive communication system can be achieved. The goal is to identify the degrees of freedom in the system which can be exploited for communication. It is assumed that existing displays which show one image at a time, at a fixed refresh rate. Unlike the initial development of VR Codes targeting 120 Hz displays (such as 3-D shutter-glasses TVs), the objective of this work is to address common displays, which typically refresh at 60 Hz.

Consider a static substrate input image and analyze how the unobtrusiveness requirement applies to the images output by the display. From our understanding of the HVS, any significant change in the displayed image slower than 30 Hz will be visible to the human eye. Consequently, when the refresh rate is 60 Hz, we can only afford to interleave, or temporally multiplex, two images in a duty cycle. So for each input substrate image, the system generates two output display images as shown in FIG. 5.

To meet the unobtrusiveness requirement, the two images must “average” in the HVS to the original substrate. Furthermore, as indicated by prior research and verified again using experiments, human vision is sensitive to luminance flicker at frequencies up to 60 Hz, particularly outside of the cone-rich fovea, suggesting that rods might play an essential role in this phenomenon. Thus it is important to make sure not to introduce luminance difference between the multiplexed images. It is found that this also reduces perception of false edges when the eyes are saccading. To further reduce this effect, a reduced visual acuity can be emulated by limiting the spatial frequency in the difference between the multiplexed images.

Without loss of generality consider a single pixel of the output image. Denoting the substrate color by s and the two multiplexed images as s₀, s₁, these requirements are formalized as: L(s₀)=L(s₁), (C(s₀)+C(s₁))/2=C(s) where L is the flicker luminance and C is a linear colorspace in which the perceived color when temporally multiplexing two colors is their average combination, as described in Section I (the description of HVS).

### Modulation

Now, consider a process of generating the multiplexed images from the substrate. Assume that the multiplexed colors satisfy the iso-luminance constraint and consider the remaining degrees of freedom. The constraint (C(s₀)+C(s₁))/2=C(s), can be rewritten as

s₀=C⁻¹(C(s)−d) (6)

s₁=C⁻¹(C(s)+d) (7)

where d=(C(s₁)−C(s₀))/2 is a 2-dimensional offset vector (the third dimension is fixed by iso-luminance) and C⁻¹ is the inverse of the colorspace mapping function C. Any choice of d will result in unobtrusive multiplexing, thus the sender can use to this vector to encode the source message. The only constraint is that both s₀ and s₁ are feasible, that is within the color gamut of the display.

This flexibility allows separation of the concern of choosing the offset vector d from using it to generate sᵢ. However, because the feasible range of d depends on the position of s within the gamut, and the shape of this range is generally a convex 2-dimensional polygon, there is no way to orthogonalize the two dimensions of d. For this practical reason, one can choose to sacrifice one degree of freedom for the benefit of further separation of concerns. Further, this restricts d to a 1-dimensional segment, e. This segment is selected as the longest segment with mid-point in C(s) that is completely contained within the gamut. FIG. 6 shows an example of such a segment selection. In particular, note that while the 2-D range of offset vector d is largely dependent on the position of s within the gamut, the longest segment is much less dependent and degenerates to a point only when s is near the primaries, i.e., vertices of the gamut, as shown in FIG. 6.

Now consider an encoder block which generates a mask image m (0≦m≦1), and a subsequent modulation block which computes the display images to be multiplexed. The modulation block uses the mask to scale the offset vector d within its feasible range, d=me/2, and derives sᵢ from s using C and its inverse as in Eq. eq:splitting. Note that when s is near the vertices of the gamut, e is very short, and therefore sᵢ are close to s and hardly discernible. Thus, there can be areas in the substrate which yield no opportunity to embed information.

For displays refreshing at higher frequencies, it is worthwhile to consider a duty cycle multiplexing more than 2 frames. The modulation problem generalizes to N-frame duty cycle: pick N vectors dᵢ such that Σᵢ dᵢ=0 and that sᵢ=C⁻¹(C(s)+dᵢ) is feasible for each i. Note that it is possible for a set of offset vectors to achieve higher contrast than two endpoints of the longest segment, e.g., if the gamut is a triangle, a 3-cycle can achieve a higher contrast than a 2-cycle.

When the substrate is dynamic, i.e., a movie, the encoder needs to generate two frames to be multiplexed for each input frame. If the movie is rated at 24 frames per second, some input frames need to be held for two output frames, while others for three. This can result in perceptible jitter. Some high-end displays inject motion-interpolated frames to avoid this. VR coding modulation should be applied after the motion interpolation.

### Comparison to Alpha Compositing

It has been speculated that alpha compositing can be used to create the overlays. However, with the better understanding of HVS and the formalized notion of unobtrusiveness, this can now be analyzed more carefully.

The embodiment multiplexes images sᵢ that the compositing approach computes given s and some mask image m. If using the Porter-Duff OVER operator with alpha multiplier α, sᵢ=αs+(1−a)mᵢ, where both s and mᵢ are expressed in the operating colorspace. Even if the appropriate linear colorspace and iso-luminance, L(m₀)=L(m₁) is chosen to avoid luminance flicker, note that the perceived average (s₀+sᵢ)/2=αs+(1−α)(m₀+m₁)/2 cannot match s exactly. At best, it is αs+β for some constant offset β, meaning that any non-zero a coefficient results in reduced contrast of the perceived image.

### Understanding the Camera for Decoding

In the previous section, a general design of a VR coding system that meets the unobtrusiveness criterion is described. The encoder converts the digital message into a baseband mask which modulates the original substrate image with high frequency chromatic flicker. Before approaching the problem of demodulation and actual encoding/decoding of messages, the characteristics of the communication channel are first identified.

### Screen-Camera Communication Channel

This section identifies specific types of signal distortion one might expect to experience between the sender and receiver of the VR coding system.
Non-signals: The camera captures light from a wide range directions, usually spanning more than the solid angle occupied by the display screen. Thus, the captured image encompasses elements in the scene beyond the transmitted image, and the decoder must detect which part of the image carries the signal of interest. This is analogous to signal detection in baseband RF decoding.
Perspective distortion: The device camera is virtually a point observing the display screen which is a non-point object. Consequently, the image it captures is subject to perspective distortion. Specifically, parts of the display screen further away from the camera occupy a smaller angle, hence fewer pixels on the camera sensor than those closer to the camera. As the features captured in the image will have a scale varying with the relative position, the decoder must estimate the scale, which is analogous to timing recovery in baseband RF decoding.
Focus and sensor resolution: Unless the display screen is positioned at the focus plane of the camera's lens, the image of each pixel of the display forms a circle of confusion which overlaps with the images of nearby pixels resulting in blur which is equivalent to inter-symbol interference in RF communications. Furthermore, the camera sensor has a finite resolution (spatial sampling frequency) which is further reduced when the captured data is subsampled in the image processing stack. Both defocus and finite resolution are effectively a limit on maximum spatial resolution.
Motion blur: Although sometimes equipped with inertial optical image stabilization, the camera device is hand-held and therefore likely experiencing shaking. As the exposure time is not infinitely small, any significant change of the camera position during exposure will result in motion blur in the image: apparent streaking along the direction of motion.
Light sensing: The CCD camera sensor has a limited dynamic range. To avoid clipping while maximizing the contrast in measured signal, the gain of the sensor needs to be adjusted to the actual radiant intensity of the display. While in practical devices, this is often accomplished through a built-in auto-gain function, gain optimized for the whole scene might not be optimal for the part of the image occupied by the display. Furthermore, the camera sensor is subject to noise affecting CCD. As a combination of several independent noise sources, the CCD read noise often exhibits normal distribution.
Color reproduction and sensing: A typical display screen contains three types of pixels—red, green, and blue. Each type can be characterized by the emitted light spectrum (color response) which is specific to the utilized light emitting technology, pixel design, and manufacturing process. To ensure perceptual color uniformity of images reproduced on different displays, this color response is typically measured through color calibration. An ICC profile characterizes the color output of a display device which can then be used to adjust the values sent to the display. Similarly the color input of a camera device can be calibrated to ensure perceptual uniformity of captured images. That said, many consumer devices are not calibrated beyond coarse factory tuning. Furthermore, many digital cameras automatically detect and neutralize color cast, that is a perceptually unnatural tint of particular color caused by the uneven spectrum of the illumination or uneven spectral absorption of the medium. This process, known as automatic white balance, is employed to better match human perception which compensates for color cast via chromatic adaptation. However, it could result in false colors for unnatural scenes. The composite result of the above is that the color transfer function of the display-camera system is often hard to accurately characterize without additional calibration.
Light interference: Both display screen surfaces and camera lenses are made from materials which are partially reflective. In result, high intensity light reflected from these surfaces can interfere with the captured image. This is equivalent to an in-band interference in RF communications.
Temporal synchronization: In a VR coding system, the display image is changing at 60 Hz. Each change is not instantaneous, but rather the pixels change state line by line starting from the top (in a typical LCD display). In analogous fashion, the pixels in the camera CCD sensors are not read all at once, but rather section by section (in a typical rolling shutter sensor). Consequently, the pixels of one captured image correspond to the display pixels at different times and likely encompass more than one display frame. On top of that, the backlight of an LCD display is often dimmed via high frequency pulse-width modulation (PWM) which means that at some time during capture the whole display can go blank.

These are the key challenges that the VR coding system must overcome. Next, the tunable parameters of the camera device are described in context of how they affect the decoder's ability to resolve the baseband mask design.

Camera Parameters

The VR codes are intended to work with existing consumer smartphones and with the camera devices already embedded in them. However, most of these devices have a number of programmatically tunable parameters which affect the image transfer in the display-to-camera channel. In this section, the preferred settings for the camera to resolve the baseband are identified.
Exposure time: The VR coding system leverages the flicker fusion to ensure that a fast sequence of contrasting images appears just as to the original substrate image to the human eye. In contrast, it is essential for the camera to be able to resolve the modulated substrate images. Therefore, the most critical camera parameter is the exposure time.
Focal length: Most modern smartphone cameras have adjustable focus lenses and auto-focus features. While auto-focus can be helpful when capturing images at various distances, the objective here is to consider the long-distance scanning application. Thus, it is best to disable auto-focus and set the focus at “infinity”. Consider the hyperfocal distance which is the smallest distance beyond which all objects appear in focus. It is approximately equal f²/Nc where f is the focal length, N is the f-stop number of the lens (derived from the aperture size) and c is the circle of confusion which in our application is determined by the pixel resolution of the images processed by the decoder, c=sensor diagonal/diagonal pixel resolution. In practice, full-resolution images are challenging to process at real-time speed. Assuming 1024×768 pixel resolution, sensor diagonal under 5 mm, f-stop at least 2.2, focal length at most 4.5 mm, H≦2.35m. this covers most application scenarios well.
White balance: Most smartphone cameras allow compensation for scene illumination and many include automatic white balance which are based on some assumptions about the color distribution of the scene. For example, the “gray world theory” describes that all scenes are gray on average. A different approach is to ensure that the histograms of each of the (R, G, B) channels in the image spans the whole dynamic range. In our application, however, such algorithms are not helpful, since the chromaticity of the display does not depend on scene illumination. In fact, they could be detrimental when the assumptions are not met, e.g., when the original substrate image is substantially tinted, leading to incorrect color correction. Fortunately, in all modern smartphone platforms, automatic white balance can be disabled and forced to daylight which corresponds to the colorspace most displays are approximately calibrated to.
ISO and metering: The ISO parameter allows adjusting the signal gain of the CCD sensor to achieve the desired lightness of the captured image. In the ideal communication system, the gain would be adjusted to the maximal value that does not cause clipping to the region of interest, i.e., the part of the captured image occupied by the display screen. While some cameras allow to programmatically set the metering areas, determining the region of interest is not trivial (requires detection of the signal in spite of all channel distortions). In the current embodiment, the metering area is set to the dead center of the sensor, since the user is instructed to aim the camera at the display. However, it is also found that the auto-gain mechanism takes significant time to converge, and when changing the exposure time programmatically, it is better to adjust the ISO by following the rule of reciprocity, e.g., if exposure time is doubled, the ISO should be halved, and vice versa.

### Exposure Time

The impact of exposure time on the chromatic contrast of the captured image. Based on the current predominance of rolling shutter cameras and market trends, this embodiment addresses camera shutters which are rolling. Thus the captured image is formed one scan (batch of pixel lines) at a time. In non-square image sensors, each scan is typically oriented along the longer edge of the sensor. In a smartphone held in portrait orientation it corresponds to scans being read left-to-right or right-to-left.

Each scan captures a fragment of the display averaged over a particular span of time with length equal to the exposure time and offset equal to the position on the sensor divided by readout speed. For explanation purposes, assume ideal display that alternates between two solid colors, 0 and 1, and refreshes instantaneously. FIG. 7 illustrates how the captured image consists of color bands formed from a series of scans at varying shutter speeds. If the exposure time tₑ is longer than the display refresh period t_{d}, then some scans will overlap the display's transition between colors. Then, compute the average color value observed during each scan and consider the chromatic contrast defined as the difference between the maximum and minimum of observed values. FIG. 8 plots chromatic contrast as a function of exposure time normalized to display refresh period. In particular, note that when tₑ=2t_{d} all spans average over same amount of 0 and 1 and the contrast drops to zero.

In practice, the display does not refresh instantaneously, but usually from top to bottom. With shutter readout from left to right, each scan observes the display refresh transition at slightly offset times. This results in stair-like diagonal banding pattern going from top-left to bottom-right. The faster the readout speed relative to display refresh frequency the more vertical the bands will be. Furthermore, the backlight of the display is modulated with PWM which results in blanking observable with fast shutter. FIG. 7 shows photographs of a 120 Hz display captured on a rolling shutter camera at different exposure times demonstrating both the stair-like pattern and blanking. Finally, as the exposure time is reduced, the non-zero noise floor of the sensor and circuitry becomes significant, reducing the overall signal-to-noise ratio. In order to capture the modulated substrate images, the preferred exposure time setting is the refresh period of the screen.

Note that with global shutter, there is a chance that the readout will unfortunately align with display refresh and prevent the camera from capturing the split images. A rolling shutter guarantees that there will be a part of the captured image that is exposed to only one split image, although the decoder must be aware that the capture phase is not constant.

### Encoding and Decoding Messages in Substrates

This section focuses on embedding messages in the baseband mask. As described in Section II, the display emits the substrate image modulated by the mask. The present technology first addresses the problem of baseband recovery—estimating the mask produced by the encoder—from the captured images. In the original VRCodes demo, metamers were embedded in an area which was constrained to be solid gray in the substrate image. However, to achieve the goal of zero dedicated space, the embodiment must work with general substrate images, in which the substrate features may be confused with the baseband modulation.

To simplify the problem, assume the substrate is static, there is no perspective distortion in the channel, and that the camera resolution is the same as display resolution, meaning that the pixels of the captured image are perfectly aligned with the pixels of the display. This allows the focus to be on a single pixel, while keeping in mind that a whole array is sent and received at a time.

Recall that the sender displays signal sᵢ=C⁻¹(C(s)+dᵢ), multiplexed in time for i=0, 1, where dᵢ is the offset vector in which the encoder embeds the message. Thus the goal of the decoder is to estimate \hat{d}ᵢ. Observe that due to lack of synchronization between sender and receiver, the decoder cannot tell whether it captured an image of s₀ or s₁. Furthermore as discussed in Section II, the captured image is likely a spatial mixture of both due to the rolling shutter. However, recall that the encoder is initially constrained to produce d=me/2 where e is a function of the substrate s and m is a scalar. Hence, it is sufficient to estimate the magnitude ∥\hat{d}∥, which is the same regardless of which of the multiplexed images was captured. This allows the banding effect to be ignored going forward.

A naive approach is to first estimate ŝ. However, the color transfer function between the display and the camera must be accounted for. The captured pixel is p=F(sᵢ), where F denotes the color transfer function. While F can be determined by observing how known colors shown on the display appear when captured, it is one of our goals to forgo such color calibration when possible. By considering several restricted cases, the present technology has identified situations where calibration is not critical.

### Case 1: Solid Substrate

First consider the scenario where the substrate is an image of solid color, i.e., s is constant, although unknown to the receiver. Consequently, any variance in the observed pixels comes from the encoder-selected d. Without knowing F, the decoder cannot determine the exact correspondence between observed p=F(sᵢ) and d. However, if the encoder is constrained to output only a binary mask, m ε {0, 1}, and ensured that there is a sufficient number of symbols with 0 and 1 over the whole image, the decoder can cluster the observed pixel colors. If Os and is are equally likely (a typically preferred property of codewords), the decoder can use nearest neighbor thresholding as a good estimator of the true d. With a 0-1 mask, and d=me/2, it is expected to have three clusters in the captured image, thus it is practical to instead use m ε {−1, 1} which results in two clusters. The decoder cannot determine the actual phase; but it can compare the spatially adjacent pixels to detect the shift from one phase to the other. This is analogous to DBPSK in RF communications. However, the rolling shutter banding also results in a phase shift and needs to be taken into account in mask design.

### Case 2: Grayscale Substrate

In a less contrived scenario, the present technology next consider grayscale substrate images. Knowing that s is grayscale restricts it to a known point in the gamut, as long as the receiver can estimate the luminance, L(s). So if F is known, the decoder can estimate ∥\hat{d}∥ as the distance of C(F′(p)) from the “whitepoint” at luminance corresponding to L(F′(p)). This approach is also applicable even if F is not given, but the decoder knows the “whitepoint”, and the encoder's mask m is binary. In this case, a clustering of the observed distance values allows estimating m.

When the “whitepoint” is not known, the decoder is facing a problem analogous to automatic white balance (AWB) described in Section II, thus the technology considers an approach similar to the “gray world theory”. The encoder is constrained to generate d that is zero on average, and then the average values for each of the R, G, B channels is estimated and these values are scaled independently so that their averages are even. Then, the embodiment assumes R=G=B or U=V=0 as the white point. An example of a result obtained using this method in FIG. 9.

### Case 3: General Substrate

Finally, the present technology embodies the most general scenario where the substrate image is composed of arbitrary colors from the gamut. In this case, even knowing F and restricting the encoder's mask m does not allow for a robust estimate because the problem is still under-specified. Even DBPSK-style differential encoding cannot reliably distinguish phase changes from naturally occurring edges in the substrate.

A solution to this problem is to exploit the programmatically adjustable exposure time of the camera, discussed in Section III. Consider two separate captured images: pₛ with short exposure time, tₑ, set to the refresh period of the screen, t_{d}; and pₗ with long exposure time, tₑ=2t_{d}. As shown in FIG. 10, the first one will record the multiplexed pixels ŝᵢ, while the second will record their time average, which is approximately s. Thus, the decoder can use the camera device to estimate ŝ directly. Assuming known color transfer F, the decoder can then estimate |\hat{d}|=|C(F′(pₛ)−C(F′(pₗ))|. We show an example of this in FIG. 10. In practice, the challenge in this method is to align the corresponding pixels in the two images.

Again, if F is not known, but the encoder is constrained to a binary mask m ε {0, 1}, then the decoder can use the distance of |C(pₛ)−C(pₗ)| to perform clustering and thresholding. In this case, it is important that C(·) is orthogonal to luminance L(·). This allows the decoder to exploit the prior that the sender emits images iso-luminant with the substrate, and avoid having to compensate for the likely gain mismatch between pₛ and pₗ.

An alternative approach is to ensure that the mask m and the substrate s are not well correlated and exploit this at the decoder. For instance, consider a 1-bit encoder which produces either m=0 or m that is a {−1, 1} checkerboard of fixed grid size. Then the decoder can look specifically for the transitions from one board tile to another—both horizontally and vertically. Unless the substrate has a similar pattern throughout the image, the decoder should be able to determine whether m is a checkerboard or zero.

Baseband Mask Design

The separation of encoding from modulation and the availability of demodulation techniques described above allow us to consider the super-channel which accepts the encoded baseband mask m and outputs a distorted \tilde{m}=|\hat{d}|. The embodiment also addresses the problem of encoding the message in the baseband mask m. Considering the characteristics of the channel, this problem is similar to that of traditional 2-dimensional visual tag design. Thus, techniques used to address perspective distortion, defocus, and color transfer in standard barcodes can be applied here.

The fundamental difference in this channel is that the maximum magnitude ∥d| varies with the substrate s. This magnitude is analogous to the gain of an RF or visible light communication channel. In particular, for colors near the gamut primaries, the gain is very low resulting in areas of low capacity for communications. Since these areas are known at the sender, the encoder can identify areas of low capacity and “encode around them”, i.e., not use these pixels for encoding. However, note that if the demodulator estimates ŝ then these areas are also known at the receiver. Thus, the decoder can simply reject areas of low gain as erasures. For such erasure channel, Maximum Distance Separable (MDS) codes, such as the Reed-Solomon code, are optimal, so the encoder can achieve channel capacity without having to exclude any areas in the substrate image.

However, 2-dimensional tags still need to correct for perspective distortion. Most use a finder pattern which is a known signal that the decoder searches for in the captured image. The finder pattern could still fall in areas of low gain. Therefore, consider a simpler tag: a 1-D barcode stretched over the whole display so that the bars are horizontal. Such codes are to a large extent robust to perspective distortion in the common practical scenario where the display is located in the same plane as the camera. It is also robust to vertical erasures, e.g., due to screen blanking. Finally it uses a simple signal for timing recovery and can be detected and decoded very quickly with limited CPU resources. The primary downside of this scheme is its low data rate, but this is one of the tenets of our overall system design which uses the VRCode embedded message for identification only.

The present technology also embodies spreading techniques such as OFDM and DSSS, assuming that perspective distortion and resolution mismatch are canceled. The initial approach assumed that the mask can only be binary, so to accommodate OFDM, which does not fit such quantization, dithering techniques were used to simulate levels of gray with poor results. The new framework which allows non-binary masks to modulate offset vector in a linear colorspace accommodates OFDM directly although the encoder needs to account for uneven gain across the substrate image. This problem can be addressed with water filling, but further research is needed.

In the previous section, the present technology demonstrates methodology resulting in a greatly-improved demonstrable working system. Based on the findings, the following technical goals are realized:
“Calibration-free VRCodes” The present method still requires color calibration on the decoder side in order for videos across all devices to look identical. However, the present method can now produce a self-consistent picture without any pre-calibration due to a nuanced understanding of perceived color-spaces.
“Zero Visual Real Estate” As explained in Section IV, the newfound technique of long-short decoding moves beyond simple solid-color embeddings. This opens up embedding digital codes for any type of substrate. Further, the findings presented in this report enable “zero visual real estate” implementations for 60 Hz displays in addition to the originally anticipated results for 120 Hz.
“Scalable codewords generation” The present technology borrows concepts from classic digital communications and achieves this with one clear separation in our encoder/decoder block diagram. The present technology provides a clear framework which allows for the improvement of current methods in the future.

Significant capacity gains may be made by generalizing our system design. Instead of the two-image system described by FIG. 1, consider a system more general such as that suggested by FIG. 11. This model increases the available dimensionality of the proposed encoder/decoder system and can fully utilize a newfound understanding of the HVS.

### Applications and Value Chain Development

Based on the present technology, a consumer-facing mobile app called Wink Browser is released on the iOS app store. This app explores the user interaction of pointing the phone at content on a display. Based on the present technology, a video player is also released which synchronizes meta data to video frames. The basic two-way user interaction is shown in FIG. 12. Full two-way interaction is possible in that one can change what is on the screen through the mobile device as well as what is on the mobile device through the use of a server-client system.

### SUMMARY OF THE INVENTION

In order to overcome the constraints imposed by transfer of data capacity and how it is perceived by the human eye, the present technology presents a methodology for understanding the HVS that culminates in a single practical system with a few assumed properties for ease of exposition and engineering. Specifically, only a single dimension in the color space is assumed for each pixel value in the substrate. Second, a 60 Hz display screen is assumed where only color frequencies are alternated for any single pixel. As described in Section III, these pixels are chosen according to maximizing along a single dimension in all three cases of solid color embedding, grayscale embedding and color image embedding.

The invention accordingly comprises the several steps and the relation of one or more of such steps with respect to each of the others, and the apparatus embodying features of construction, combinations of elements and arrangement of parts that are adapted to affect such steps, all is exemplified in the following detailed disclosure, and the scope of the invention will be indicated in the claims.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

### BRIEF DESCRIPTION OF THE DRAWINGS

For a more complete understanding of the invention, reference is made to the following description and accompanying drawings, in which:

FIG. 1 depicts VRCoding System;

FIG. 2 depicts Table of Experimental Survey of HVS;

FIG. 3 depicts Method of Determining ISO-Luminant colors;

FIG. 4 depicts Model of the Human Visual System;

FIG. 5 depicts Two-Screen VR Coding System Embedding a Digital Message;

FIG. 6 depicts Heatmap of Feasible Regions of the Color Gamut;

FIG. 7 depicts Varying Exposure Time Captures of 120 Hz Display;

FIG. 8 depicts Effect of Rolling Shutter on Chromatic Contrast;

FIG. 9 depicts Demodulating Grayscale Substrates Using Chrominance;

FIG. 10 depicts Demodulating Color Substrates Using Long-Short Exposure Differences;

FIG. 11 depicts Capacity Increase by Mathematical Generalization; and

FIG. 12 depicts Use Cases Requiring Two-Way Communication Between the Display and Camera Device.

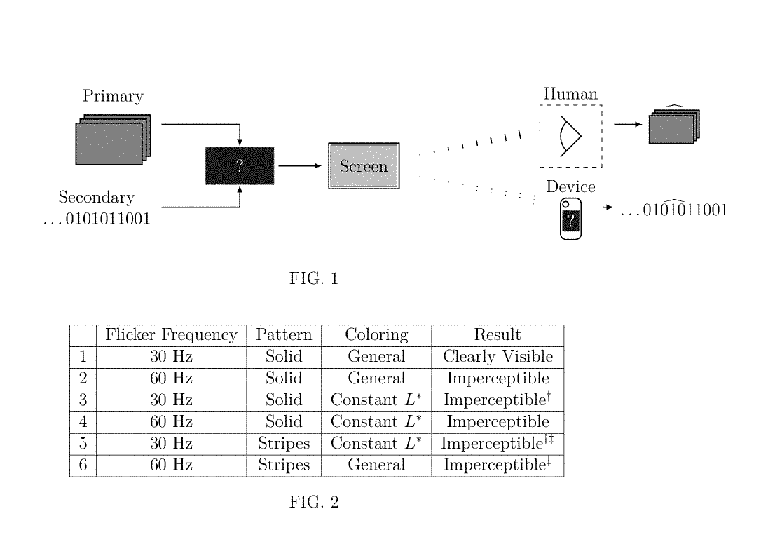

### DETAILED DESCRIPTION OF THE DRAWINGS

FIG. 2 summarizes a typical experimental survey: Screens with high refresh rate (those capable of 60 Hz flicker) can induce flicker fusion for general sources. Standard screens however require iso-luminant sources. We note that in settings 3 and 5, fusion was imperceptible for most settings except when the distance between colors was high, implying that constant L* is an imperfect proxy for iso-luminance. Additionally, saccading induced another HVS artifact when flickered sources had patterns with hard edges (settings 5 and 6).

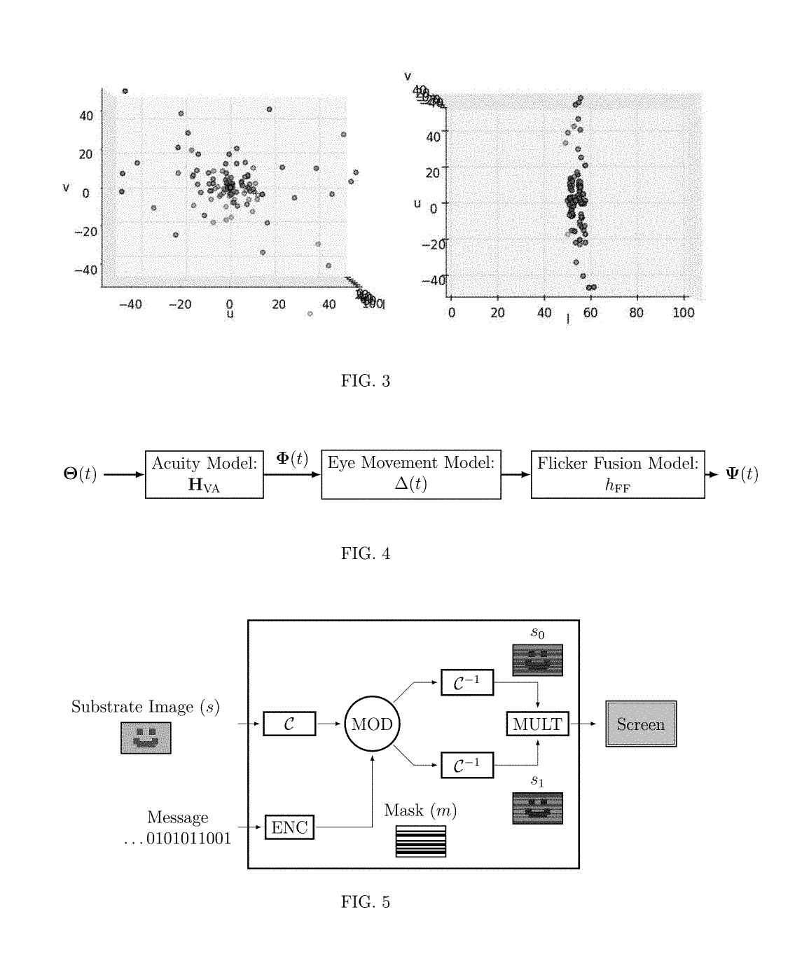

FIG. 3 shows two perspectives of Iso-luminance. The left panel of FIG. 3 depicts Iso-luminant points in the U-V plane. The right panel of FIG. 3 depicts Iso-luminant points in the L-U plane. Projection of a perceptually iso-luminant surface resulting from the color tuning experiment: The reference center-point is 50% gray, which has CIELUV coordinates (l,u,v)=(0.5, 0,0). While being spread evenly across the U-V plane, the surface is approximately linar in the L-U plane. Moreover, L is nearly constant.

FIG. 4 describes a model of the Human Visual System used to build the techniques here within.

FIG. 5 depicts the VRCode system embeds a digital message by modulating the substrate image, s, (in desired colorspace C) into multiple images, sᵢ, which are then temporally multiplexed on the display screen.

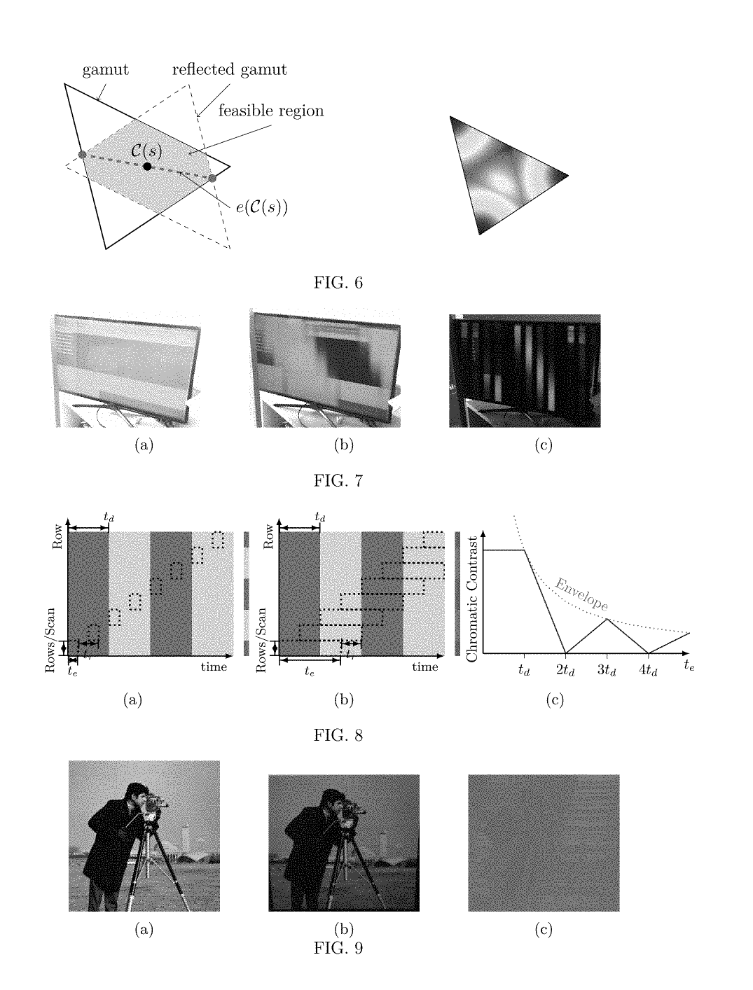

FIG. 6 On the left, the feasible region is depicted as the intersection of the gamut and its reflection around C(s). The region is generally a convex polygon, and the longest segment e(C(s)) is its longest diagonal. On the right, a heat-map of the length of e for each point in the gamut. The length is shortest in the blue areas near the corners of the gamut (the primary colors).

FIG. 7 depicts Varying Exposure Time Captures of 120 Hz Display. A 120 Hz display flickering a solid green image over another image, photographed at different exposure times, tₑ. When exposure time is very short, the PWM backlight becomes visible. Figure FIG. 7(a) depicts tₑ=1/60s=2t_{d}. Figure FIG. 7(b) depicts tₑ=1/125s≈t_{d}. Figure FIG. 7(c) depicts tₑ=1/3205s<<t_{d}.

FIG. 8 describes the effect of rolling shutter on the captured image when the display is multiplexing two solid colors. Read out time, tᵣ, and number of rows per scan, determine the size of bands formed on the screen. The ratio of exposure time, tₑ, to display refresh time, t_{d}, determines the chromatic contrast. Figure FIG. 8(a) depicts Fast shutter behavior. Figure FIG. 8(b) depicts Slow shutter behavior. Figure FIG. 8(c) depicts Contrast vs. exposure time behavior.

FIG. 9 depicts three steps of demodulating grayscale substrates using chrominance. FIG. 9(a) depicts the original substrate image. FIG. 9(b) depicts the captured modulated image. FIG. 9(c) depicts the chrominance of the captured image after basic color balancing.

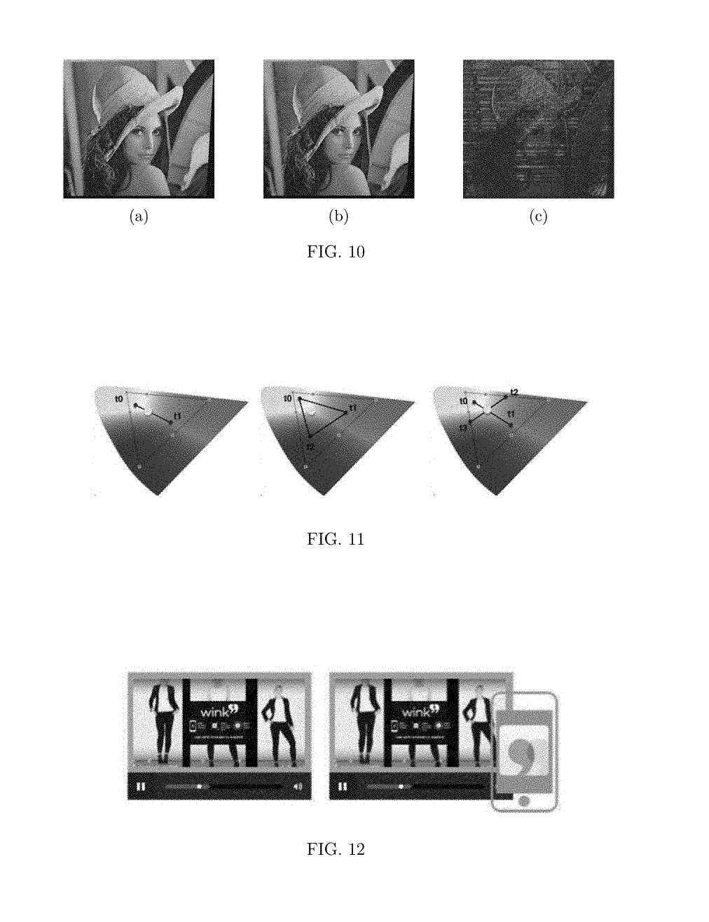

FIG. 10(a) depicts the long-exposure capture of the modulated image. FIG. 10(b) depicts the short-exposure capture of the modulated image. FIG. 10(c) depicts the difference between the images after alignment.

What is claimed:

1. A method for communicating machine-readable information and images for human perception through a single display comprising:
generating sets of two or more digital images given a desired human-perceivable image by computing, for each pixel of the desired image, sets of distinct colors in some color space such that: their average in that color space matches the pixel's color, their luminance difference in that color space is within predefined threshold, and their difference is a function of the machine-readable information;
displaying the generated images on the display in temporal sequence at a frame rate beyond some chosen frequency threshold;
capturing one or more images of the display using exposure time shorter than the period corresponding to the chosen frequency threshold, and processing the captured images together with other available data to obtain the machine-readable information.

2. The method of claim 1, wherein the color space is such that two colors of the same luminance in that color space are expected not to perceivably flicker to a human observer at the chosen frequency threshold.

3. The method of claim 1, wherein the chosen frequency threshold is beyond the assumed human flicker fusion frequency threshold.

4. The method of claim 1, wherein the procedure is repeated continuously while the desired human-perceivable image input is dynamically updated over a series of frames corresponding to a computer-generated animation or playback of a video.

5. The method of claim 1, wherein every pixel color in the generated images is computed utilizing a color table generated ahead of time.

6. The method of claim 1, wherein the said color space is adjusted to an estimated color space of the display device.

7. The method of claim 1, wherein the machine-readable information is a part of a message encoded in several parts, which is then decoded and reassembled from multiple parts obtained from multiple captured images of the display.

8. The method of claim 1, wherein two captured images are aligned and subtracted within some color space.

9. The method of claim 1, wherein an additional captured image of the display is captured using exposure time longer than two periods corresponding to the assumed frequency threshold.

10. The method of claim 9, wherein the additional long-exposure captured image is aligned with a short-exposure image and subtracted within some color space.

11. The method of claim 1, wherein the difference in each generated set of colors is a two-dimensional chroma vector in some color space, and the spatial changes in the phase of the vector are a function of the machine-readable information.

12. The method of claim 11, wherein spatial changes in the phase of a two-dimensional chroma vector in some color space are computed for each pixel in the captured images of the display.

13. The method of claim 1, wherein the other available data for computing the machine-readable information is the approximate physical location of the display.

14. The method of claim 1, wherein the machine-readable information is a unique identifier that is further resolved by an auxiliary system after decoding.

15. A system comprising:
a server system which encodes a partial request and stores a temporary association of the request with a display device;
a display device which given a desired human-perceivable image or image stream, displays a stream of distinct images such that a long exposure in some color space of two or more consecutive displayed images matches the desired image, and their difference encodes a unique identifier;
a client device which uses a camera component to continuously capture images, and processes the captured images to decode a unique identifier; and upon successful decoding of the identifier submits the identifier to the server system using a computer network along with additional information to complete the request.

16. The system of claim 15, wherein the unique identifier encoded by the display device corresponds to the specific desired human-perceivable image.

17. The system of claim 15, wherein the request specifies sound synchronized to the desired human-perceivable image stream given to the display.

18. The system of claim 15, wherein the additional information submitted by the client device to the server system is an identifier of information previously stored in the server system.

19. The system of claim 15, wherein in response to the submitted request, the display device displays another human-perceivable image or image stream and encodes another unique identifier.
